(19) United States
(12) Patent Application Publication
(10) Pub. No.: US 2025/0170682 A1
(43) Pub. Date: May 29, 2025

(54) MACHINE TOOL AND METHOD TO OPERATE THIS TYPE OF MACHINE TOOL

(71) Applicant: Schwäbische Werkzeugmaschinen GmbH, Schramberg-Waldmössingen (DE)

(72) Inventors: Marcus MIXNER, Hardt (DE); Stefan WEBER, Bösingen (DE)

(21) Appl. No.: 18/953,828

(22) Filed: Nov. 20, 2024

(30) Foreign Application Priority Data
Nov. 27, 2023 (EP) 23212435.4

(51) Int. Cl. B23Q 39/04

(52) U.S. Cl. CPC B23Q 39/044

(57) ABSTRACT

A machine tool having a machine frame, a first work spindle, a second work spindle, a first pivot carrier which is assigned to the first work spindle and which is swivel mounted around a first pivot carrier axis, a first workpiece table and a second workpiece table, and a second pivot carrier which is assigned to the second work spindle and which is swivel mounted around a second pivot carrier axis. The machine tool also includes a first workpiece table and a second workpiece table, the first pivot carrier and the second pivot carrier can each be moved from a first pivot position into a second pivot position, and the interference area of the first workpiece table and/or the interference area of the second workpiece table on the first pivot carrier protrude(s) outwards beyond the swivel area of the first pivot carrier transversely to the first pivot carrier axis.

### CROSS-REFERENCE TO RELATED APPLICATION(S)

This application claims the benefit of European application EP23212435.4 filed Nov. 27, 2023, which is incorporated herein by reference.

The invention relates to a machine tool with a machine frame, with at least one first work spindle, with at least one second work spindle, with at least one first pivot carrier allocated to the first work spindle, which is mounted in the machine frame to swivel around a first pivot carrier axis and that includes at least one first workplace table and at least one second workpiece table, wherein the first workpiece table and the second workpiece table are arranged on opposite sides of the first pivot carrier on the first pivot carrier with respect to the first pivot carrier axis and each define an interference region in which they can be arranged or are arranged, and with at least one second pivot carrier which is associated with the second work spindle and is mounted in the machine frame so as to be pivotable around a second pivot carrier axis extending parallel to the first pivot carrier axis and spaced apart from the first pivot carrier axis, and which includes at least one first workpiece table and at least one second workpiece table, which are positioned on opposite sides of the second pivot carrier on the second pivot carrier with respect to the second pivot carrier axis and each define an interference region in which they can be arranged or are arranged, wherein the first pivot carrier and the second pivot carrier each move from a first pivot position in which the respective first workpiece table is arranged in a working area and is accessible to the first or second work spindle into a second pivot position in which the respective second workpiece table is arranged in the working area and is accessible to the first or second work spindle. Furthermore, the invention also relates to a method for operating this type of machine tool.

Machine tools are known from the state of the art in various embodiments and designs. For example, these can include machine frames upon which a workpiece table is arranged, where workpieces can be detachably fastened. The workpieces can be processed by a work spindle on the machine tool.

In known machine tools, the workpiece table is loaded with workpieces while the work spindle is out of operation. In addition, the work spindle is at rest if the workpieces are removed from the workpiece table after processing. This can lead to long downtimes for the machine tool.

There are also other known machine tools, in which a so-called pivot carrier is swivel mounted on the machine frame, on which two workpiece tables are arranged that are positioned on opposite sides of the pivot carrier with regard to the pivot carrier axis of the pivot carrier. By rotating the pivot carrier around the pivot carrier axis, one workpiece table is moved from a work area to a loading area and at the same time the workplace table in the loading area is moved to the work area. This can reduce the downtimes for the machine tool.

Other pivot carriers are known where two workpiece tables are arranged on each side of the pivot carrier, whereby each workpiece table is allocated its own work spindle. This must ensure a distance to the work spindles that allows the pivot carrier to swivel without collision. This means that the distance between the pivot carrier axis and the work spindle is very large and the machine tool requires a lot of space.

### SUMMARY

One task of an embodiment of the invention is to propose a machine tool in which the distance between the pivot carrier axis and the work spindle is reduced, in particular while retaining or improving processing times.

This task is solved in a machine tool mentioned at the outset in that the interference area of the first workpiece table and/or the interference area of the second workpiece table of the first pivot carrier protrudes/protrude outwards beyond the pivoting area of the first pivot carrier transversely to the first pivot carrier axis.

As the machine tool includes a first pivot carrier and a second pivot carrier, each including a first workpiece table and a second workpiece table, the distances of the work spindles to the pivot axes can be kept short. The pivoting of two pivot carriers, with a workpiece table on each side, uses a smaller rotation circle respectively than one large pivot carrier with two workpiece tables on each side.

Because the interference area of the first workpiece table and/or the interference area of the second workpiece table of the first pivot carrier protrudes outwards transversely to the first pivot carrier axis beyond the pivoting range of the first pivot carrier, the first pivot carrier can be designed with a smaller pivoting range, i.e. with reduced dimensions, while maintaining or improving accessibility by the first work spindle. This also allows the first workpiece table and/or the second workpiece table to be arranged at a reduced distance from the first work spindle.

The machine tool can process a large number of workpieces because the first workpiece tables can be accessed by the first work spindle and the second work spindle in the first pivot position, and the second workpiece tables can be accessed in the second pivot position and the workpieces arranged therein can be processed.

In principle it is conceivable that only one first workpiece table and only one second workpiece table are arranged on each of the two pivot carriers of the machine tool, opposite one another in relation to the pivot carrier axis. Opposite one another means that, if one of the workpiece tables is positioned on the site of the pivot carrier that is facing the work spindle, the respective other workpiece table is positioned on the side of the pivot carrier facing away from the work spindle.

In addition, embodiments of the machine tool are conceivable in which the first pivot carrier includes two first workpiece tables on one side as well as two second workpiece tables on the other side that are arranged on opposite sides to one another in relation to the first pivot carrier axis. This also applies in the same way for the second pivot carrier, which can include two first workpiece tables and two second workpiece tables that are arranged on opposite sides to one another in relation to the second pivot carrier axis.

These kinds of embodiments can be scaled up further so that each pivot carrier includes at least three first workpiece tables and three second workpiece tables or four first workpiece tables and four second workpiece tables etc.

The movement from the first pivot position into the second pivot position can involve a rotation through 180° around the first pivot axis or rather the second pivot axis.

The phrase “or rather” is taken to mean “and in the alternative case” and continues the relation in the previous sentence or partial sentence.

It proves to be advantageous if the at least one first workpiece table and/or the at least one second workpiece table on the first pivot carrier and/or if the at least one first workpiece table and/or the at least one second workpiece table on the second pivot carrier respectively is/are designed to pick up and hold at least one workpiece. In particular, the workpiece tables can be designed in such a way that more than just one workpiece can be arranged on them.

The machine tool can be designed to be compact with regard to its extension along the vertical y axis if the interference areas of the first workpiece table and/or the second workpiece table of the first pivot carrier overlaps/overlap with the pivoting area of the second pivot carrier when moving from the first pivoting position to the second pivoting position and back.

As the interference areas of the first workpiece table and/or the second workpiece table of the first pivot carrier overlap with the pivoting area of the second pivot carrier during the move from the first pivoting position to the second pivoting position, the distance between the first pivot carrier axis and the second pivot carrier axis can be reduced compared to an arrangement in which the interference areas do not overlap with the pivoting area of the second pivot carrier.

The total extension of the machine tool parallel to a vertical y axis can be further reduced if the first pivot carrier and the second pivot carrier, viewed transversely to the first pivot carrier axis, are arranged without overlapping each other or if the first pivot carrier and the second pivot carrier, viewed transversely to the first pivot carrier axis, overlap each other in sections.

If the first pivot carrier and the second pivot carrier overlap one another in sections, then the first pivot carrier can be arranged in some areas in the second pivot carrier or vice versa. In this case it is possible, for example, for the second pivot carrier to be designed longer with regard to a horizontal x axis than the first pivot carrier, whereby this is arranged in a recessed area. For example, the first pivot carrier and the second pivot carrier can be designed shaped like a drum and have a larger radius transversely to the horizontal x axis at both ends with regard to the horizontal x axis as in the inner areas that lie between them. In this case one of the pivot carriers, which is shorter than the other pivot carrier, can be arranged in these recessed areas.

A compact design with regard to the vertical y axis can be further improved if the interference area of the first workpiece table and/or the interference area of the second workpiece table of the second pivot carrier protrudes/overlaps the swivelling area of the second pivot carrier outwards transversely to the second pivot carrier axis and overlaps/overlap with the swivelling area of the first pivot carrier when moving from the first pivot position to the second pivot position and back.

In particular, if the first workpiece table and/or the second workpiece table overlaps with its interference areas with the second pivot carrier when moving from the first pivot position to the second pivot position and the first workpiece table and/or the second workpiece table of the second pivot carrier overlaps with the first pivot carrier when moving from the first pivot position to the second pivot position, a particularly compact design of the machine tool can be realised with respect to the vertical y axis.

In principle, it is conceivable that the first workpiece table of the first pivot carrier, if it is moved from the first pivot position to the second pivot position, is arranged in this at any position on the machine tool. The same applies to the second workpiece table on the first workpiece carrier if this is moved from the second pivot position to the first pivot position and back.

Furthermore, embodiments of the machine tool are also conceivable in which a third workpiece table and/or a fourth workpiece table are additionally provided, wherein the first workpiece table, second workpiece table, third workpiece table and fourth workpiece table are arranged evenly with respect to the first pivot carrier axis and a move from the first pivot position to the second pivot position takes place in a carousel-like manner.

However, it proves to be advantageous if the machine tool includes one or more first workpiece tables and one or more second workpiece tables each on a pivot carrier.

In order to load and unload the machine tool, it proves to be advantageous in this case if, in the first pivot position of the first pivot carrier and/or in the first pivot position of the second pivot carrier, the respective second workpiece table is arranged in a loading area, and/or if, in the second pivot position of the first pivot carrier and/or in the second pivot position of the second pivot carrier, the respective first workpiece table is arranged in the loading area.

In principle, it is conceivable that the first workpiece table and/or the second workpiece table of the first pivot carrier and/or of the second pivot carrier are each fixed non-rotatably to their pivot carrier.

However, it is easier to process using the first work spindle or rather the second work spindle if the first workpiece table on the first pivot carrier is swivel-mounted around a workpiece table axis that runs parallel to the first pivot carrier axis, and if the second workpiece table on the first pivot carrier is swivel-mounted around a second workpiece table axis that runs parallel to the first pivot carrier axis, whereby the swivel areas on the first workpiece table and the second workpiece table form the respective interference areas of the first workpiece table or rather the second workpiece table and/or that the first workpiece table on the second pivot carrier is swivel-mounted around a first workpiece table access that runs parallel to the second pivot carrier axis, and if the second workpiece table on the second pivot carrier is swivel-mounted around a second workpiece table axis that runs parallel to the second pivot carrier axis, whereby the swivel areas of the first workpiece table and the second workpiece table form the respective interference areas of the first workpiece table or rather the second workpiece table.

If the first workpiece tables and/or the second workpiece tables on the first pivot carrier or rather the second pivot carrier intervene in the swivelling range of the second pivot carrier or the first pivot carrier when moving from the first pivot position to the second pivot position or back again, it proves to be advantageous for collision-free operation of the machine tool if the first pivot carrier can be arranged in a first release position, in which the first workpiece table and the second workpiece table can be arranged in a position and/or alignment in which the second pivot carrier can be moved from the first pivot position into the second pivot position and vice versa with its first workpiece table and its second workpiece table without a collision and/or if the second pivot carrier can be arranged in a second release position, in which the first workpiece table and the second workpiece table can be arranged in a position and/or alignment, in which the first pivot carrier can be moved from the first pivot position to the second pivot position and vice versa with its first workpiece table and its second workpiece table without a collision.

This can ensure that the first workpiece tables and the second workpiece table do not overlap with their interference areas when they are moved from the first pivot position to the second pivot position and back, thus avoiding a collision.

In principle, the movement of the first pivot carrier into the first release position or rather the second pivot carrier into the second release position can be carried out in any way. It proves to be advantageous if the movement of the first pivot carrier into the first release position comprises a rotation or swivelling of the first pivot carrier around the first pivot carrier axis and/or a rotation or swivelling of the first workpiece table around the first workpiece table axis and/or of the second workpiece table around the second workpiece table axis and/or if the movement of the second pivot carrier into the second release position comprises a rotation or swivelling of the second pivot carrier around the second pivot carrier axis and/or a rotation or swivelling of the first workpiece table around the first workpiece table axis and/or of the second workpiece table around the second workpiece table axis.

In particular, if the first workpiece tables and the second workpiece tables are arranged non-rotatably and rigidly on the pivot carriers, it proves to be advantageous if the movement into the first release position or into the second release position exclusively comprises a movement of the first pivot carrier by rotating or swivelling around the first pivot carrier axis, or of the second pivot carrier by rotating or swivelling around the second pivot carrier axis.

If the first workpiece tables and/or the second workpiece tables are each rotatable around the first workpiece table axis or second workpiece table axis, then they can be rotated around their own workpiece table axis only or also in addition to rotation around the first pivot carrier axis or second pivot carrier axis.

Embodiments of the machine tool are conceivable in which the first pivot carrier and the second pivot carrier can be decoupled with respect to their kinematics in an independent operating mode and can be moved separately and independently of one another into the first pivot position and into the second pivot position, into the first release position and/or the second release position and/or in which the first pivot carrier and the second pivot carrier are coupled in a dependent operating mode with respect to their kinematics and can be moved together and simultaneously to the first pivot position and the second pivot position, into the first release position and/or the second release position.

If the first pivot carrier and the second pivot carrier can be decoupled with respect to their kinematics in an independent operating mode and can be moved separately and independently of one another into the first pivot position, into the second pivot position, into the first release position and/or the second release position then each pivot carrier can be allocated its own drive unit.

If the first pivot carrier and the second pivot carrier can be moved to the individual positions in dependent operating mode, then a joint drive can be assigned to the first pivot carrier and the second pivot carrier, by means of which both pivot carriers can be moved in a coupled manner.

Furthermore, embodiments of the machine tool are conceivable in which the first pivot carrier axis and the second pivot carrier axis extending parallel to the first pivot carrier axis extend parallel to a horizontal x axis, wherein the first pivot carrier axis and the second pivot carrier axis are spaced apart with respect to a vertical y axis, in particular are arranged one above the other with respect to the vertical y axis and, in particular, are aligned with respect to the vertical y axis extending transversely to it, or in which the first pivot carrier axis and the second pivot carrier axis extending parallel to the first pivot carrier axis extend parallel to a vertical y axis, or in which the first pivot carrier axis and the second pivot carrier axis extending parallel to the first pivot carrier axis extend parallel to a vertically extending y axis, wherein the first pivot carrier axis and the second pivot carrier axis are spaced apart from one another with respect to a horizontal x axis, in particular arranged next to one another with respect to the horizontal x axis and in particular aligned with one another with respect to the horizontal x axis extending transversely to it.

In one embodiment of the machine tool it is provided that the first pivot carrier axis and the second pivot carrier axis as well as the first workpiece table axes and the second workpiece table axis run parallel to one another and parallel to the horizonal x axis or that the first pivot carrier axis, the second pivot carrier axis and the first workpiece table axes and the second workpiece table axis run parallel to one another and parallel to the vertical y axis.

In the machine tool embodiments described above, all axes of the workpiece tables and the pivot carriers run parallel to one another.

The first spindle axis of the first work spindle and/or the second spindle axis of the second work spindle can run transversely to this in both spatial orientations of the pivot carrier axes and the associated workpiece table axes.

The machine tool can be designed to be compact in terms of its spatial dimensions if, in the first pivot position and in the second pivot position, the first workpiece table and the second workpiece table of a pivot carrier are each arranged point-symmetrically to one another with respect to the associated pivot carrier axis of the respective pivot carrier on which they are arranged and, if the respective pivot carrier axis runs horizontally, the first workpiece table and the second workpiece table are arranged offset to one another with respect to a vertical axis and, in particular, the pivoting ranges of the first workpiece table and the second workpiece table of the associated pivot carrier overlap with a vertical plane running through the pivot carrier axis, and if the respective pivot carrier axis runs vertically, the first workpiece table and the second workpiece table are arranged offset relative to one another with respect to a horizontal axis and, in particular, the pivoting ranges of the first workpiece table and the second workpiece table of the associated pivot carrier overlap with a horizontal plane running through the pivot carrier axis.

This creates a so-called interlocked arrangement of the workpiece tables on the pivot carrier, whereby the machine tool can be designed in a more space-saving manner. Furthermore, this can reduce the distance between the first work spindle and/or second work spindle to the first pivot carrier axis or rather the second pivot carrier axis.

This interlocked arrangement can be achieved, for example, if, in the first pivot position, the distance between the first workpiece tables and the pivot axis is less than maximally possible.

The pivoting areas of the first workpiece tables and the pivoting areas of the second workpiece tables allocated to the respective first workpiece tables can overlap.

In this kind of embodiment, the respective workpiece table axes can be arranged offset to one another with regard to a transverse axis. If the respective workpiece table axes run, for example, parallel to a horizontal x axis, the first workpiece table axis is offset to the second workpiece table axis with regard to a vertical y axis.

In embodiments in which the first workpiece table axis and the second workpiece table axis are arranged parallel to a vertical y axis, these can be arranged offset to one another with respect to the horizontal x axis running transversely to them when they overlap on the pivot carrier.

Furthermore, it proves to be advantageous if on the first pivot carrier the distance between the first pivot carrier axis and the first workpiece table axis is less than the interference area of the first workpiece table and/or the distance between the first pivot carrier axis and the second workpiece table axis is less than the interference area of the second workpiece table.

Furthermore, on the second pivot carrier the distance between the second pivot carrier axis and the first workpiece table axis can be less than the interference area of the first workpiece table and/or the distance between the second pivot carrier axis and the second workpiece table axis can be less than the interference area of the second workpiece table.

This also enables or further improves the machine tool designed with reduced installation space.

The at least one first work spindle can be rotatably mounted around a first spindle axis and/or the at least one second work spindle can be rotatably mounted around a second spindle axis. The first spindle axis and/or second spindle axis can run parallel to a horizonal z axis that runs transversely to the vertical y axis and transversely to the horizontal x axis.

In one embodiment of the machine tool, the first work spindle and the second work spindle are arranged vertically above one another, if the first pivot carrier axis and the second pivot carrier axis that runs parallel to the first pivot carrier axis run parallel to the horizontal x axis, and if the first work spindle and the second work spindle are arranged horizontally next to one another, if the first pivot carrier axis and the second pivot carrier axis that runs parallel to the first pivot carrier axis run parallel to the vertical y axis.

In order to enable loading and/or unloading of one workpiece table while simultaneously processing the opposite workpiece table, it proves to be advantageous if the first pivot carrier comprises a first partition wall by which the first workpiece table and the second workpiece table are spatially separated from each other in the first pivot position and in the second pivot position and the loading area is shielded from the working area in full or at least in sections and/or if the second pivot carrier includes a second partition wall by means of which the first workpiece table and the second workpiece table are spatially separated from one another in the first pivot position and in the second pivot position and the loading area is shielded from the working area in full or at least in sections.

In this case a machine tool operator is screened when accessing the loading area from the working area by the first partition wall and/or by the second partition wall.

The working area can extend across both the first pivot carrier and the second pivot carrier. Furthermore, embodiments of the machine tool are conceivable in which the first pivot carrier includes a first working area and the second pivot carrier includes a second working area, spatially separated from one another.

Furthermore, in this case the first pivot carrier can include a first loading area and the second pivot carrier can include a second loading area, spatially separated from one another.

The machine tool can be realised in a simplified manner if a joint working area and a joint loading area are allocated to the first pivot carrier and the second pivot carrier.

In particular, if the first workpiece table and the second workpiece table overlap each other at least in sections, it can be provided in one embodiment of the machine tool that the first partition wall of the first pivot carrier can be flexibly and/or elastically bent around an axis running parallel to the first pivot carrier axis and/or that the second partition wall of the second pivot carrier can be flexibly and/or elastically bent around an axis running parallel to the second pivot carrier axis.

This allows the separation of the working area from the loading area to be adapted more easily.

In principle it is conceivable that the first pivot carrier is arranged directly adjacent to the second pivot carrier without gaps and/or joints. This enables the machine tool to be designed in a reduced space with regard to its dimensions.

In one embodiment of the machine tool, a provision is made that the machine frame includes at least one separating section, which is arranged between the first pivot carrier and the second pivot carrier, wherein the first partition wall of the first pivot carrier, the separating section of the machine frame and the second partition wall of the second pivot carrier spatially separate the working area from the loading area in the first pivot position and in the second pivot position in full or at least in sections without gaps and/or joints.

In addition, the task is solved by a method for operating this kind of machine tool, in particular with at least one of the aforementioned features, with the following steps:
a. Moving the first pivot carrier from the first pivot position or from the second pivot position into a first release position, in which the first workpiece table and the second workpiece table are arranged in a position and/or alignment in which the second pivot carrier can be moved from the first pivot position to the second pivot position and vice versa with its first workpiece table and its second workpiece table free of collision with regard to the first pivot carrier;
b. Moving the second pivot carrier from the first pivot position into the second pivot position or from the second pivot position into the first pivot position; and
c. Moving the first pivot carrier from the first release position into the first pivot position or rather into the second pivot position;
   and/or
d. Moving the second pivot carrier from the first pivot position or from the second pivot position into a second release position, in which the first workpiece table and the second workpiece table are arranged in a position and/or alignment in which the first pivot carrier can be moved from the first pivot position to the second pivot position and vice versa with its first workpiece table and its second workpiece table free of collision with regard to the second pivot carrier;
e. Moving the first pivot carrier from the first pivot position into the second pivot position or from the second pivot position into the first pivot position; and
f. Moving the second pivot carrier from the second release position into the first pivot position or rather into the second pivot position.

In a further development of the method, it proves to be advantageous if the movement of the first pivot carrier into the first release position comprises a rotation of the first pivot carrier around the first pivot carrier axis and/or a rotation or swivelling of the first workpiece table around the first workpiece table axis and/or of the second workpiece table around the second workpiece table axis and/or if the movement of the second pivot carrier into the second release position comprises a rotation of the second pivot carrier around the second pivot carrier axis and/or a rotation or swivelling of the first workpiece table around the first workpiece table axis and/or of the second workpiece table around the second workpiece table axis.

Further features, details and advantages of the invention result from the attached patent claims, from the graphic representation and subsequent description of a preferred embodiment of the machine tool and the method.

### BRIEF DESCRIPTION OF THE DRAWINGS

The drawing shows:

FIG. 1A perspective front view with partially transparent representation of the first pivot carrier and the second pivot carrier of a machine tool according to the invention;

FIG. 2A schematic flowchart of an exemplary embodiment of the method according to the invention.

### DETAILED DESCRIPTION

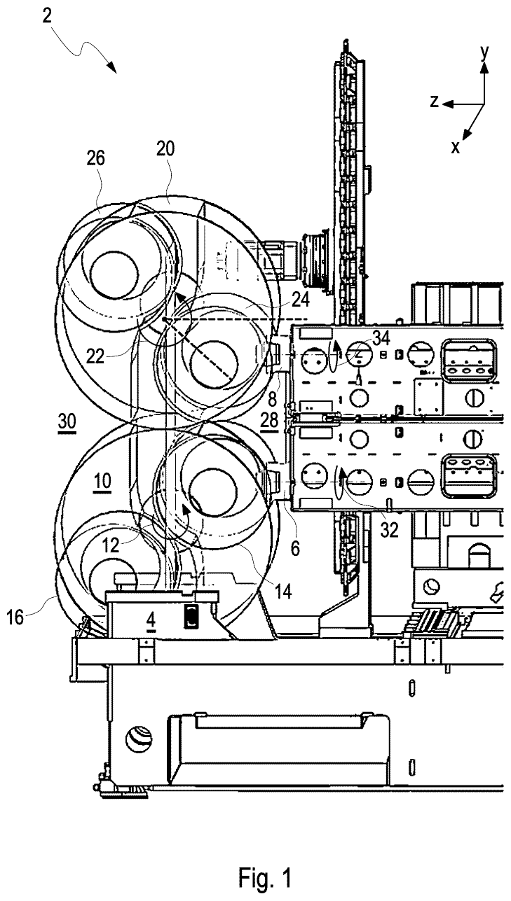

FIG. 1 shows a first exemplary embodiment of a machine tool referred to as a whole with reference sign 2. Furthermore, the machine tool 2 includes a machine frame 4, a first work spindle 6 and a second work spindle 8.

The machine tool 2 comprises a first pivot carrier 10 allocated to the first work spindle 6, which is swivel mounted in the machine frame 4 around a first pivot carrier axis 12 and which comprises a first workpiece table 14 and a second workpiece table 16. The first workpiece table 14 and the second workpiece table 16 are arranged on the first pivot carrier 10 on opposite sides to one another with regard to the first pivot carrier axis 12. They each define an interference area in which they can be arranged or are arranged. The first workpiece table 14 of the first pivot carrier 10 is rotatably mounted around a first workpiece table axis 15 and the second workpiece table 16 is rotatably mounted around a second workpiece table axis 17 on the first pivot carrier 10.

Furthermore, the machine tool 2 includes a second pivot carrier 20 allocated to the second work spindle 8, which is swivel mounted in the machine frame 4 around a second pivot carrier axis 22 that runs parallel to the first pivot carrier axis 12 and at a distance from the first pivot carrier axis 12. The second pivot carrier 20 also includes a first workpiece table 24 and a second workpiece table 26. The first workpiece table 24 and the second workpiece table 26 are arranged on the second pivot carrier 20 opposite one another with regard to the second pivot carrier axis 22. The first workpiece table 24 is rotatably mounted around a first workpiece table axis 25 and the second workpiece table 26 is rotatably mounted around a second workpiece table axis 27 on the second pivot carrier 20.

The first workpiece table 24 and the second workpiece table 26 of the second pivot carrier 20 also each define interference areas in which they can be arranged or are arranged.

The first pivot carrier 10 and the second pivot carrier 20 can each be moved from a first pivot position (FIG. 1), in which the respective first workpiece table 14, 24 is arranged in a working area and is accessible to the first work spindle 6 or the second work spindle 8, into a second pivot position, in which the respective second workpiece table 16, 26 is arranged at the working area 28 and is accessible to the first work spindle 6 or the second work spindle 8.

In the embodiment example shown in FIG. 1, during the move from the first pivot position to the second pivot position, the respective first workpiece tables 14, 24 can be moved from the working area 28 into a loading area 30, in which the workpiece tables 14, 16, 24, 26 can be loaded with workpieces.

In the embodiment example shown in FIG. 1, the first workpiece tables 14, 24 and the second workpiece tables 16, 26 are designed in such a way that their interference areas each project outwardly beyond their pivot carrier 10, 20 transversely to the pivot carrier axis 12, 22 of the respective pivot carrier 10, 20.

Furthermore, the first pivot carrier 10 and the second pivot carrier 20 are arranged relative to one another in such a way that they are arranged one above the other and in alignment with one another with respect to a vertical y axis and are arranged with their respective swivelling ranges directly next to one another. This means that the interference areas of the first workpiece table 14 and the second workpiece table 16 of the first pivot carrier 10 enter the pivoting range of the second pivot carrier 20, at least in sections, when moving from the first pivoting position to the second pivoting position and vice versa. Conversely, the interference areas of the first workpiece table 24 and the second workpiece table 26 of the second pivot carrier 20 reach into the swivelling range of the first pivot carrier 10 if the second pivot carrier is moved from the first pivot position to the second pivot position or vice versa.

In order to avoid a collision when moving from the first pivot position to the second pivot position, the first pivot carrier 10 can be arranged in a first release position in which the first workpiece table 14 and the second workpiece table 16 can be arranged in a position and/or alignment in which the second pivot carrier 20 with its first workpiece table 24 and its second workpiece table 26 can be moved collision-free from the first pivot position to the second pivot position and vice versa. The second pivot carrier 20 can be arranged in a second release position, in which the first workpiece table 24 and the second workpiece table 26 can be arranged in a position and/or alignment in which the first pivot carrier 10 with its first workpiece table 14 and its second workpiece table 16 can be moved collision-free from the first pivot position to the second pivot position and back.

In order to move the first pivot carrier 10 into the first release position, the pivot carrier 10 can be rotated around the first pivot carrier axis 12. In addition, the first workpiece table 14 can be rotated around the first workpiece table axis 15 and/or the second workpiece table 16 can be rotated around the second workpiece table axis 17. The same applies to the second pivot carrier 20, which can be rotated around the second pivot carrier axis 22 to move it to the second release position and/or the first workpiece table 24 is rotated around the first workpiece table axis 25 and the second workpiece table 26 is rotated around the second workpiece table axis 27.

In the embodiment example shown in FIG. 1, the first pivot carrier axis 12, the second pivot carrier axis 22, the first workpiece table axes 15, 25 and the second workpiece table axes 17, 27 run parallel to each other and parallel to a horizontal x axis. The first work spindle 6 and the second work spindle 8 are arranged offset to one another in relation to a vertical y axis and above one another, in particular aligned with one another. The first working spindle 6 is rotatably mounted around a first spindle axis 32 and the second working spindle 8 is rotatably mounted around a second spindle axis 34. The first spindle axis 32 and the second spindle axis 34 run parallel to a horizontal z axis. This runs transversely to the horizontal x axis with the vertical y axis.

FIG. 1 shows an embodiment example of the machine tool 2, in which the first pivot carrier 10 and the second pivot carrier 20 are moved in an interlocked arrangement, which forms the first pivot position and the second pivot position, respectively. Here, the first workpiece table 14, 24 and the second workpiece table 16, 26 of a pivot carrier 10, 20 are each arranged point-symmetrically to one another with respect to the associated pivot carrier axis 12, 22 of the respective pivot carrier 10, 20 on which they are arranged. In the horizontal orientation of the respective pivot carrier axis 10, 20, the respective first workpiece table 14, 24 and the second workpiece table 16, 26 are arranged offset to each other with respect to a vertical y axis. This reduces the distance between the first workpiece table axis 15 and the second workpiece table axis 17 to the first pivot carrier axis 12 and reduces the distance between the first workpiece table axis 25 and the second workpiece table axis 27 to the second pivot carrier axis 22. This also reduces the distance of the first work spindle 6 to the first pivot carrier axis 12 and the distance of the second work spindle 8 to the second pivot carrier axis 22.

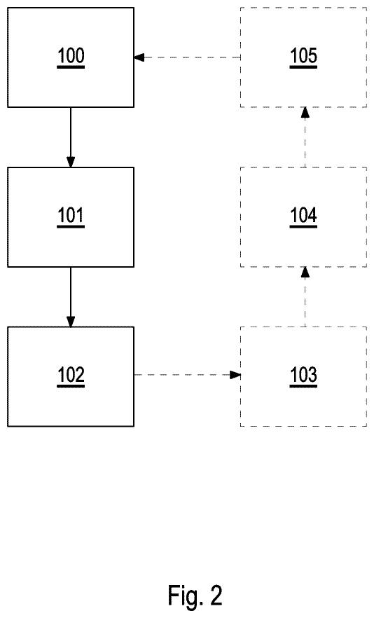

FIG. 2 shows a schematic flow diagram of an embodiment of a method according to the invention for operating a machine tool 2. The method is described below with the aid of the representation in FIG. 1:

In a first step 100, the first pivot carrier 10 is moved from the first pivot position or from the second pivot position into a first release position, in which the first workpiece table 14 and the second workpiece table 16 are arranged in a position and/or alignment in which the second pivot carrier 20 with its first workpiece table 24 and its second workpiece table 26 can be moved from the first pivot position into the second pivot position and vice versa without collision with respect to the first pivot carrier 10.

In a subsequent step 101, the second pivot carrier 20 is moved from the first pivot position to the second pivot position or from the second pivot position to the first pivot position.

In a subsequent step 102, the first pivot carrier 10 is moved from the first release position back to the first pivot position or rather to the second pivot position.

Alternatively or additionally, in a step 103, the second pivot carrier 20 can be moved from the first pivot position or from the second pivot position into a second release position, in which the first workpiece table 24 and the second workpiece table 26 are arranged in a position and/or alignment in which the first pivot carrier 10 with its first workpiece table 14 and its second workpiece table 16 can be moved from the first pivot position into the second pivot position and vice versa without collision with respect to the second pivot carrier 20.

After this, in a step 104, the first pivot carrier 10 is moved from the first pivot position to the second pivot position or from the second pivot position to the first pivot position.

Subsequently, in a step 105, the second pivot carrier 20 is moved from the second release position back into the first pivot position or rather into the second pivot position.

Subsequently, the work tables 14, 16, 24, 26 now arranged in the working area 28 can be processed and the work tables 14, 16, 24, 26 arranged in the loading area 30 can be loaded.

The features of the invention disclosed in the above description, in the claims as well as in the drawing, both individually and in any combination, may be essential in the realisation of the invention in its various embodiments within the scope of protection of the following claims.

### REFERENCE SYMBOL LIST

2 Machine tool
4 Machine frame
6 First work spindle
8 Second work spindle
10 First pivot carrier
12 First pivot carrier axis
14 First workpiece table
15 First workpiece table axis
16 Second workpiece table
17 Second workpiece table axis
20 Second pivot carrier
22 Second pivot carrier axis
24 First workpiece table
25 First workpiece table axis
26 Second workpiece table
27 Second workpiece table axis
28 Working area
30 Loading area
32 First spindle axis
34 Second spindle axis

1. A machine tool comprising:
a machine frame,
at least one first work spindle,
at least one second work spindle,
at least one first pivot carrier which is assigned to the first work spindle and which is swivel mounted in the machine frame around a first pivot carrier axis, and
which comprises at least one first workpiece table and at least one second workpiece table,
wherein the first workpiece table and the second workpiece table are arranged on opposite sides of the first pivot carrier on the first pivot carrier with respect to the first pivot carrier axis and each define an interference region in which they can be arranged or are arranged, and
at least one second pivot carrier associated with the second work spindle, which is swivel mounted in the machine frame around a second pivot carrier axis extending parallel to the first pivot carrier axis and spaced from the first pivot carrier axis, and
which comprises at least one first workpiece table and at least one second workpiece table, which are arranged on the second pivot carrier on opposite sides of the second pivot carrier with respect to the second pivot carrier axis and each define an interference region in which they can be arranged or are arranged,
wherein the first pivot carrier and the second pivot carrier can each be moved from a first pivot position, in which the respective first workpiece table is arranged in a working area and is accessible to the first and second work spindles, respectively, into a second pivot position, in which the respective second workpiece table is arranged in the working area and is accessible to the first and second work spindles, respectively,
wherein the interference area of the first workpiece table and/or the interference area of the second workpiece table of the first pivot carrier protrudes/protrude outwards beyond the pivoting range of the first pivot carrier transversely to the first pivot carrier axis.

2. The machine tool according to claim 1, wherein the interference areas of the first workpiece table and/or the second workpiece table of the first pivot carrier overlaps/overlap with the pivoting area of the second pivot carrier when moving from the first pivoting position to the second pivoting position and back.

3. The machine tool according to claim 1, wherein the first pivot carrier and the second pivot carrier, viewed transversely to the first pivot carrier axis, are arranged without overlapping with respect to one another, or in that the first pivot carrier and the second pivot carrier, viewed transversely to the first pivot carrier axis, overlap one another in sections.

4. The machine tool according to claim 1, wherein the interference area of the first workpiece table and/or the interference area of the second workpiece table of the second pivot carrier projects/overlaps the pivot region of the second pivot carrier outwards transversely to the second pivot carrier axis and overlaps/overlap with the pivot region of the first pivot carrier during the movement from the first pivot position into the second pivot position and back.

5. The machine tool according to claim 1, wherein in the first pivot position of the first pivot carrier and/or in the first pivot position of the second pivot carrier, the respective second workpiece table is arranged in a loading area, and/or in that in the second pivot position of the first pivot carrier and/or in the second pivot position of the second pivot carrier, the respective first workpiece table is arranged in the loading area.

6. The machine tool according to claim 1, wherein the first workpiece table of the first pivot carrier is swivel mounted around a first workpiece table axis that runs parallel to the first pivot carrier axis, and that the second workpiece table of the first pivot carrier is swivel mounted around a second workpiece table axis that runs parallel to the first pivot carrier axis, whereby the swivel areas of the first workpiece table and the second workpiece table form the respective interference areas of the first workpiece table or rather the second workpiece table and/or that the first workpiece table of the second pivot carrier is swivel mounted around the first workpiece table axis that runs parallel to the second pivot carrier axis, and that the second workpiece table of the second pivot carrier is swivel mounted around the second workpiece table axis that runs parallel to the second pivot carrier axis, whereby the swivel areas of the first workpiece table and the second workpiece table form the respective interference areas of the first workpiece table or rather the second workpiece table.

7. The machine tool according to claim 1, wherein the first pivot carrier can be arranged in a first release position in which the first workpiece table and the second workpiece table can be arranged in a position and/or alignment in which the second pivot carrier can be moved with its first workpiece table and its second workpiece table collision-free from the first pivot position into the second pivot position and vice versa and/or that the second pivot carrier can be arranged in a second release position, in which the first workpiece table and the second workpiece table can be arranged in a position and/or alignment in which the first pivot carrier with its first workpiece table and its second workpiece table can be moved collision-free from the first pivot position into the second pivot position and vice versa.

8. The machine tool according to claim 7, wherein the movement of the first pivot carrier into the first release position comprises a rotation or pivoting of the first pivot carrier around the first pivot carrier axis and/or a rotation or pivoting of the first workpiece table around the first workpiece table axis and/or of the second workpiece table around the second workpiece table axis and/or that the movement of the second pivot carrier into the second release position comprises a rotation or pivoting of the second pivot carrier around the second pivot carrier axis and/or a rotation or pivoting of the first workpiece table around the first workpiece table axis and/or of the second workpiece table around the second workpiece table axis.

9. The machine tool according to claim 1, wherein the first pivot carrier and the second pivot carrier can be decoupled in an independent operating mode with respect to their kinematics, separately and independently of one another into the first pivot position, into the second pivot position, into the first release position and/or into the second release position, and/or in that the first pivot carrier and the second pivot carrier can be moved into a dependent operating mode with respect to their kinematics, jointly and simultaneously into the first pivot position, into the second pivot position, into the first release position and/or the second release position.

10. The machine tool according to claim 1, wherein the first pivot carrier axis and the second pivot carrier axis running parallel to the first pivot carrier axis run parallel to a horizontal x axis, whereby the first pivot carrier axis and the second pivot carrier axis are spaced apart with respect to a vertical y axis, in particular are arranged one above the other with respect to the vertical y axis and, in particular, are aligned with respect to the vertical y axis extending transversely to it, or in which the first pivot carrier axis and the second pivot carrier axis running parallel to the first pivot carrier axis extend parallel to a vertical y axis, or in which the first pivot carrier axis and the second pivot carrier axis running parallel to the first pivot carrier axis extend parallel to a vertical y axis, wherein the first pivot carrier axis and the second pivot carrier axis are spaced apart from one another with respect to a horizontal x axis, in particular arranged next to one another with respect to the horizontal x axis and in particular aligned with one another with respect to the horizontal x axis extending transversely to it.

11. The machine tool according to claim 1, wherein the first pivot carrier axis and the second pivot carrier axis as well as the first workpiece table axes and the second workpiece table axis run parallel to one another and parallel to the horizonal x axis or that the first pivot carrier axis, the second pivot carrier axis and the first workpiece table axes and the second workpiece table axes run parallel to one another and parallel to the vertical y axis.

12. The machine tool according to claim 1, wherein in the first pivot position and in the second pivot position the first workpiece table and the second workpiece table of a pivot carrier are each arranged point-symmetrically to one another with respect to the associated pivot carrier axis of the respective pivot carrier on which they are arranged and, if the respective pivot carrier axis runs horizontally, the first workpiece table and the second workpiece table are arranged offset to one another with respect to a vertical axis and, in particular, the pivoting ranges of the first workpiece table and the second workpiece table of the associated pivot carrier overlap with a vertical plane running through the pivot carrier axis, and if the respective pivot carrier axis runs vertically, the first workpiece table=and the second workpiece table are arranged offset relative to one another with respect to a horizontal axis and, in particular, the pivoting ranges of the first workpiece table and the second workpiece table of the associated pivot carrier overlap with a horizontal plane running through the pivot carrier axis.

13. The machine tool according to claim 1, wherein the first work spindle and the second work spindle are arranged vertically above one another, if the first pivot carrier axis and the second pivot carrier axis that runs parallel to the first pivot carrier axis run parallel to a horizontal x axis, and if the first work spindle and the second work spindle are arranged horizontally next to one another, if the first pivot carrier axis and the second pivot carrier axis that runs parallel to the first pivot carrier axis run parallel to a vertical y axis.

14. A method for operating a machine tool according claim 1, comprising the steps:
moving the first pivot carrier from the first pivot position or from the second pivot position into a first release position, in which the first workpiece table and the second workpiece table are arranged in a position and/or alignment in which the second pivot carrier can be moved from the first pivot position to the second pivot position and vice versa with its first workpiece table and its second workpiece table free of collision with regard to the first pivot carrier;
moving the second pivot carrier from the first pivot position into the second pivot position or from the second pivot position into the first pivot position; and
moving the first pivot carrier from the first release position into the first pivot position or rather into the second pivot position; and/or
moving the second pivot carrier from the first pivot position or from the second pivot position into a first release position, in which the first workpiece table and the second workpiece table are arranged in a position and/or alignment in which the first pivot carrier can be moved from the first pivot position to the second pivot position and vice versa with its first workpiece table and its second workpiece table free of collision with regard to the second pivot carrier;
moving the first pivot carrier from the first pivot position into the second pivot position or from the second pivot position into the first pivot position; and
moving the second pivot carrier from the second release position into the first pivot position or rather into the second pivot position.

15. The method according to claim 14, wherein the movement of the first pivot carrier into the first release position comprises a rotation or pivoting of the first pivot carrier around the first pivot carrier axis and/or a rotation or pivoting of the first workpiece table around the first workpiece table axis and/or of the second workpiece table around the second workpiece table axis and/or that the movement of the second pivot carrier into the second release position comprises a rotation or pivoting of the second pivot carrier around the second pivot carrier axis and/or a rotation or pivoting of the first workpiece table around the first workpiece table axis and/or of the second workpiece table around the second workpiece table axis.
